(19) United States
(12) Patent Application Publication
(10) Pub. No.: US 2014/0110549 A1
(43) Pub. Date: Apr. 24, 2014

(54) PROTECTIVE SHEATH WORKING WITH A FIXER FOR HANDHELD, PORTABLE, MOBILE DEVICES

(71) Applicant: Michael Chau-Lun CHANG, Taipei City (TW)

(72) Inventor: Michael Chau-Lun CHANG, Taipei City (TW)

(21) Appl. No.: 13/657,884

(22) Filed: Oct. 23, 2012

(51) Int. Cl. F16M 13/02

(52) U.S. Cl. 248/314

(57) ABSTRACT

A protective sheath working with a fixer for handheld, portable, mobile devices has a positioning frame that is to be mounted onto an external fixer. The positioning frame has an enclosure using its inner wall to hold an external mobile device in position. The enclosure includes a first connecting portion that is detachable and configured to engage with the fixer. The fixer serves to hang the positioning frame over an external article so as to suspend the mobile device. Thereby, the mobile device can be easily and quickly mounted on or dismounted from any nearby handrail.

### BACKGROUND OF THE INVENTION

1. Technical Field

The present invention relates to a protective sheath working with a fixer for handheld, portable, mobile devices, which is a portable tool used to hold and suspend a mobile electronic device, such as a mobile phone, a portable game player, an electronic book, a GPS device or a tablet computer.

2. Description of Related Art

Recently, handheld, mobile devices such as mobile phones and tablet computers have been popular, and nowadays almost everyone has one. While these mobile devices are relatively compact and light-weight, holding them in hand for a sustained time period is still a significant, accumulative burden to muscle, and this is particularly true for people lacking exercise.

There are some fixers designed for small-size mobile devices, but these fixers commonly fail to provide the advantages desired by users, such as being easy to mount and dismount, being compact and light, and being retractable, thereby being more portable. Therefore, the existing fixing tools need to be improved.

### SUMMARY OF THE INVENTION

The objective of the present invention is to provide a portable protective sheath for working with a fixer for mobile devices, such as mobile phones, portable game players, electronic books, GPS devices and tablet computers, wherein the protective sheath overcomes various problems of the prior art as described above.

For achieve the foregoing objective, the disclosed protective sheath has a positioning frame to be mounted onto an external fixer. The protective sheath has the following characteristics.

The positioning frame has an enclosure that uses its inner wall to hold an external mobile device in position. The positioning frame includes a first connecting portion that is detachable and configured to engage with the fixer. The fixer serves to hold the positioning frame over an external article, so as to suspend a mobile device.

Thereby, the present invention is helpful to prevent users' muscle fatigue and ache caused by overuse of neck and shoulder muscles.

### DETAILED DESCRIPTION OF THE INVENTION

FIG. 1 through FIG. 14 depicts a first embodiment of the present invention. As shown, the disclosed protective sheath has a positioning frame 2 to be mounted onto an external fixer.

The positioning frame 2 has an enclosure 22. The enclosure 22 has its inner wall configured to hold an external mobile device 6, which may be a mobile phone, a portable game player, an electronic book, a GPS device or a tablet computer. The positioning frame 2 has a first connecting portion 20 that is detachable and configured to engage with a fixer. The fixer serves to hold the positioning frame 2 over an external article, thereby suspending the mobile device 6.

Therein, the enclosure 22 of the positioning frame 2 can be directly put around the mobile device 6 to act as a protective sheath for the mobile device 6 to provide a cushioning function. Alternatively, the enclosure of the positioning frame may be formed as a sucking disc.

The positioning frame 2 also has a base 21, around which the enclosure 22 is formed such that the base 21 and the inner wall of the enclosure 22 jointly form a positioning recess 23 for accommodating and holding the external mobile device 6. The first connecting portion 20 may be deposited on the outer wall of the enclosure 22. Alternatively, the first connecting portion 20 may be such deposited that it is at the reverse side of the base 21 with respect to the side where the positioning recess 23 is defined.

The base 21 may be provided with a window 27 communicated with the positioning recess 23. In the case where the mobile device 6 is one with a hooting function, the window 27 is configured to expose the camera lens of the mobile device 6 at the exterior through the base 21, thereby facilitating its taking pictures. Alternatively, the window may be formed on the enclosure 22, for exposing an I/O port, a volume adjuster or other functional port provided at the lateral of the mobile device 6 at the exterior of the enclosure 22.

The fixer comprises an extension rod 1 and a securing member 3. The first connecting portion 20 of the positioning frame 2 is to be combined with one end of the extension rod 1 and the securing member 3 is provided at the other end of the extension rod 1 for securing the extension rod 1 as well as the positioning frame 2 onto an external article. The external article may be a planar or bar-like article. The extension rod 1 is rigid in either a vertical direction or a horizontal direction. The securing member 3 can grasp a horizontal or vertical, planar or bar-like article, so that when a user touches and operates the mobile device 6, the mobile device 6 is strongly positioned over the external article by the extension rod 1 and the securing member 3, and is prevented from swinging and being displaced.

The external article may be a horizontal handrail or a vertical handrail 72 provided in a public transportation vehicle for passengers to hold.

The securing member 3 has at least one movable clamping jaw 31 or 32.

The securing member 3 has at least two symmetrical movable clamping jaws 31 and 32. Each of the clamping jaws 31 and 32 is provided with a pivot 33 or 34. The pivot 33 or 34 is formed with a threaded hole 331 or 341. The threaded hole 331 or 341 on the pivot 33 or 34 of the clamping jaw 31 or 32 is configured to receive a threaded bolt 35. The threaded bolt 35 serves to adjust an included angle between the clamping jaws 31 and 32 unilaterally, so as to hold or release the external article. The threaded bolt 35 has one end provide with an adjusting lever 351 for a user to operate and thereby drive the threaded bolt 35 to rotate.

Alternatively, the securing member 3a has at least two symmetrical movable clamping jaws 31a and 32a and a sheath 38a housing the clamping jaws 31a and 32a at their roots. Each of the clamping jaws 31a and 32a is provided with a pivot 33a or 34a. Each of the pivots 33a and 34a is formed with a threaded hole 331a or 341a. The sheath 38a is formed with two threaded holes 381a and 382a aligned with the pivots 33a and 34a, respectively. Each of the threaded holes 331a and 341a on the pivots 33a and 34a of the clamping jaws 31a and 32a is pierced together with the corresponding threaded hole 381a or 382a on the sheath 38a by a threaded bolt 35a or 36a. The threaded bolts 35a and 36a serve to adjust an included angle between the clamping jaws 31a and 32a bilaterally, so as to hold or release the external article. Each of the threaded bolts 35a and 36a has one end provided with an adjusting lever 351a or 361a for a user to operate and thereby drive the threaded bolt 35a or 36a to rotate.

Alternatively, the securing member 3c has at least two symmetrical movable clamping jaws 31c and 32c and the driver 37c is provided on the securing member 3c for driving the clamping jaws 31c and 32c and thereby adjusting an included angle between the clamping jaws 31c and 32c. The driver 37c may be a motor.

The securing member 3, 3a, 3b or 3c is tailed by a second connecting portion 30, 30a, 30b or 30c. The extension rod 1, 1a, 1b has it's the other end provided with a first linking portion 11, 11a or 11b for engaging with the second connecting portion 30, 30a, 30b or 30c of the securing member 3, 3a, 3b or 3c. The second connecting portion 30, 30a, 30b or 30c and the first linking portion 11, 11a or 11b are combined by insertion, buckle engagement, embedding, embracing, rotational connection, pivotal connection, suction, magnetism, screwing connection, velcro tapes, adhesive or being formed integratedly.

The clamping jaw 31b or 32b has a releasing device 320b. The releasing device 320b includes a root 321b pivotally connected to the securing member 3b, and a tip 322b that is pivotally connected to the root 321b and is far from the securing member 3b. The root 321b and the tip 322b have their connecting surfaces each provided with a positioning hole 323b or 324b. A positioning rod 325b passes through the positioning holes 323b, 324b so as to fix the tip 322b with respect to the root 321b. When there is an urgent need to detach the securing member 3b from the horizontal handrail 71 or the vertical handrail 72 in the public transportation vehicle, the positioning rod 325b of the releasing device 320b can be pulled out to allow the tip 322b to swing outward, so that the securing member 3b can be invalidated by pulling open the releasing device 320b.

The extension rod 1, 1a or 1b may be a unitary member or a composite member. In the later case, the rod body 1b is formed by telescoped tubes, so that the extension rod 1b is allowed to have multi-stage extension, thereby increasing an overall using length of the extension rod.

Alternatively, the extension rod 1a is formed by links pivotally linked by one or more movable joints 10a, so that the rod body 1a is foldable and is allowed to have multi-stage extension, thereby increasing an overall using length of the extension rod.

The extension rod 1, 1a or 1b has one end provided with a second linking portion 12, 12a, 12b for engaging with the first connecting portion 20 of the positioning frame 2. The first connecting portion 20 and the second linking portion 12, 12a are combined by insertion, buckle engagement, embedding, embracing, rotational connection, pivotal connection, suction, magnetism, screwing connection, velcro tapes, adhesive or being formed integratedly.

The positioning frame 2 has its surface, where the mobile device 6 contacts, provided with a cushion 43, so as to enhance the anti-slip effect of the positioning frame 2 on the surface of the mobile device 6.

Alternatively, the enclosure 22a of the positioning frame 2a comprises an immovable bracket 221a deposited at one side of the base 21a, and a movable bracket 222a movably deposited at an opposite side of the base 21a. The movable bracket 222a is movably provided on the base 21a by slide, pull or rotation of a guide system 24a, a rail system, a tooth-notch engagement system or a gear system. The movable bracket 222a and the immovable bracket 221a are first adjusted to fittingly receive the mobile device 6 and then the movable bracket 222a is driven by an embracing means, a screw means, an adhesive means, a hydraulic means, a surface-tension means, a pressuring means, a pulling spring 25a, a suction means or a torque means to move toward the immovable bracket 221a, so as to hold the mobile device 6 firmly between the movable bracket 222a and the immovable bracket 221a regardless of how the mobile device 6 is sized.

The positioning frame 2a has its surface, where the mobile device 6 contacts, provided with a cushion 43, so as to enhance the anti-slip effect of the positioning frame 2a on the surface of the mobile device 6.

While the movable bracket 222a of the positioning frame 2a is configured to move at one side of the base 21a for adjusting the capacity of the positioning frame 2a, the positioning frame 2a can pivot on the first connecting portion 20a to rotate with respect to the extension rod 1, 1a or 1b up to 90 degrees.

On the inner surface of the base 21a of the positioning frame 2a or on the cushion 43, there is provided at least one sucking disc 26a for holding the mobile device 6, thereby ensuring close connection between the positioning frame 2a and the mobile device 6 to make the mobile device 6 get secured firmly.

The sucking disc 26a may be provided on the inner surface of the base 21a or the cushion 43 by forming integratedly, adhering, embedding or inserting.

Alternatively, as shown in FIG. 12 and FIG. 13, the positioning frame 2b or 2c may be formed without a base and only uses the enclosure 22b or 22c to hold the external mobile device 6. In this case, the first connecting portion 20b or 20c is deposited on the outer wall of the enclosure 22b or 22c. The enclosure 22b or 22c may be a loop or a part of a reversed U shape, and the first connecting portion 20, 20a, 20b, 20c may be straight or bent.

The positioning frame 2 or 2a may be designed as product-specific jacket sized according to the mobile device 6 it will hold. The term jacket herein includes a protective sheath, a protective case, a protective film, a mobile pouch, a protective purse, a protective housing, a wrapper, a leather sheath or the casing of the mobile device 6 itself.

The positioning frame 2 or 2a may be customized into a protective sheath or a protective case according to different mobile devices 6 exclusively, and then combined with the extension rod 1, 1a or 1b through a first connecting portion 20 or 20a of a common specification.

The positioning frame 2, 2b or 2c and the first connecting portion 20, 20b or 20c are combined by means of a first buckle member 81 and a second buckle member 82, so that the first connecting portion 20, 20b, 20c can be quickly assembled to and disassembled from the positioning frame 2, 2b or 2c. When having the first connecting portion 20, 20b or 20c removed therefrom, the positioning frame 2, 2b or 2c may be used independently as a simple protective sheath of the mobile device 6.

Having the configuration described above, the protective sheath is convenient to carry and can be normally put around the mobile device 6 for protection. With the securing member 3, 3a, 3b, 3c, the protective sheath having the positioning frame 2 or 2a holding a mobile electronic device 6, such as a mobile phone, a portable game player, an electronic book, a GPS device or a tablet computer, can be easily and rapidly fixed to a horizontal handrail 71 or a vertical handrail 72 that is provide in a public transportation vehicle for passengers to hold. Thereby, a user who wants to use the mobile device 6 in his/her long or short trip taking the public transportation vehicle is enabled to use the mobile device 6 conveniently without holding the device with his/her hand, thereby being prevented from muscle fatigue and ache caused by overuse of neck and shoulder muscles.

FIG. 15 discloses a second embodiment of the present invention. Therein, the fixer comprises a securing member 3, with which the first connecting portion 20 of the positioning frame 2 is combined. The securing member 3 serves to secure the positioning frame 2 onto an external article that may be a planar or a bar-like article. The securing member 3 can grasp a horizontal or vertical, planar or bar-like article, so that when a user touches and operates the mobile device 6, the mobile device 6 is strongly positioned over the external article by the securing member 3 and prevented from swinging or being displaced.

The securing member 3 has a second connecting portion 30 for engaging with the first connecting portion of the positioning frame 2. The second connecting portion 30 and the first connecting portion 20 are combined by insertion, buckle engagement, embedding, embracing, rotational connection, pivotal connection, suction, magnetism, screwing connection, velcro tapes, adhesive or being formed integratedly.

### BRIEF DESCRIPTION OF THE DRAWINGS

FIG. 1 is a front view of a first embodiment of the present invention;

FIG. 2 is a top view of FIG. 1;

FIG. 3 is a perspective view of the positioning frame as shown in FIG. 1;

FIG. 4 is a front view of an additional mode of use of the present invention;

FIG. 5 is a front view of another additional mode of use of the present invention;

FIG. 6 is a top view of FIG. 5;

FIG. 7 is a partially enlarged applied view of FIG. 5;

FIG. 8 is a front view of still another additional mode of use of the present invention;

FIG. 9 is a front view of the positioning frame as shown in FIG. 8;

FIG. 10 is an applied view of the present invention;

FIG. 11 is another applied view of the present invention;

FIG. 12 is a perspective view of an additional mode of use of FIG. 3;

FIG. 13 is a perspective view of an additional mode of use of FIG. 3;

FIG. 14 is a perspective view of FIG. 3 taken from a different viewpoint; and

FIG. 15 is a top view of a second embodiment of the present invention.

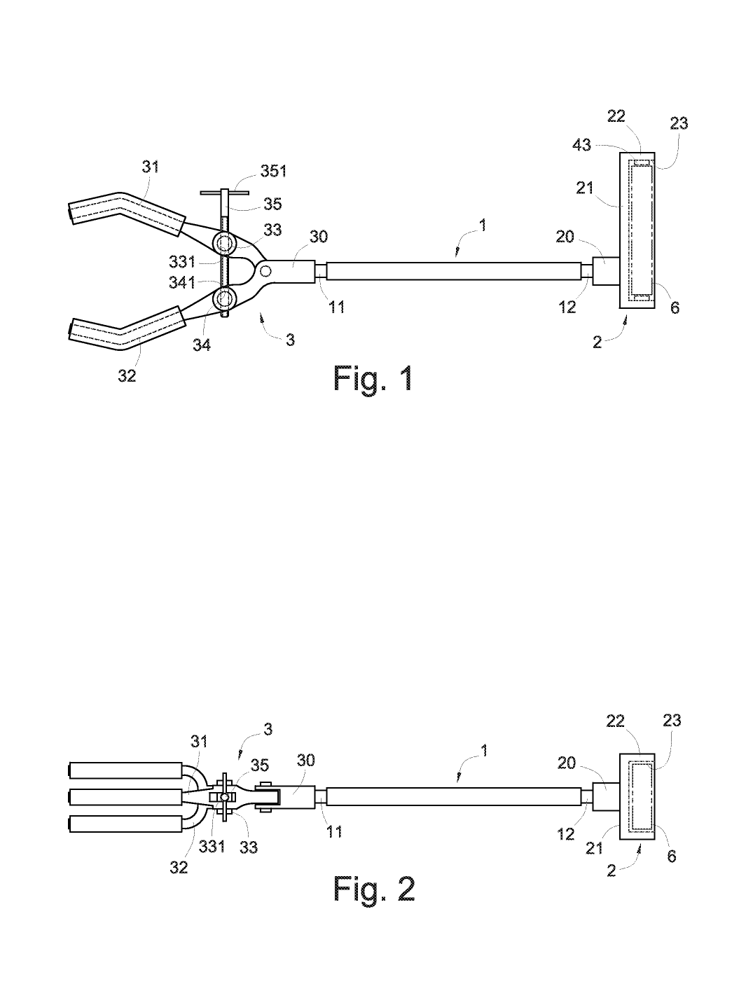

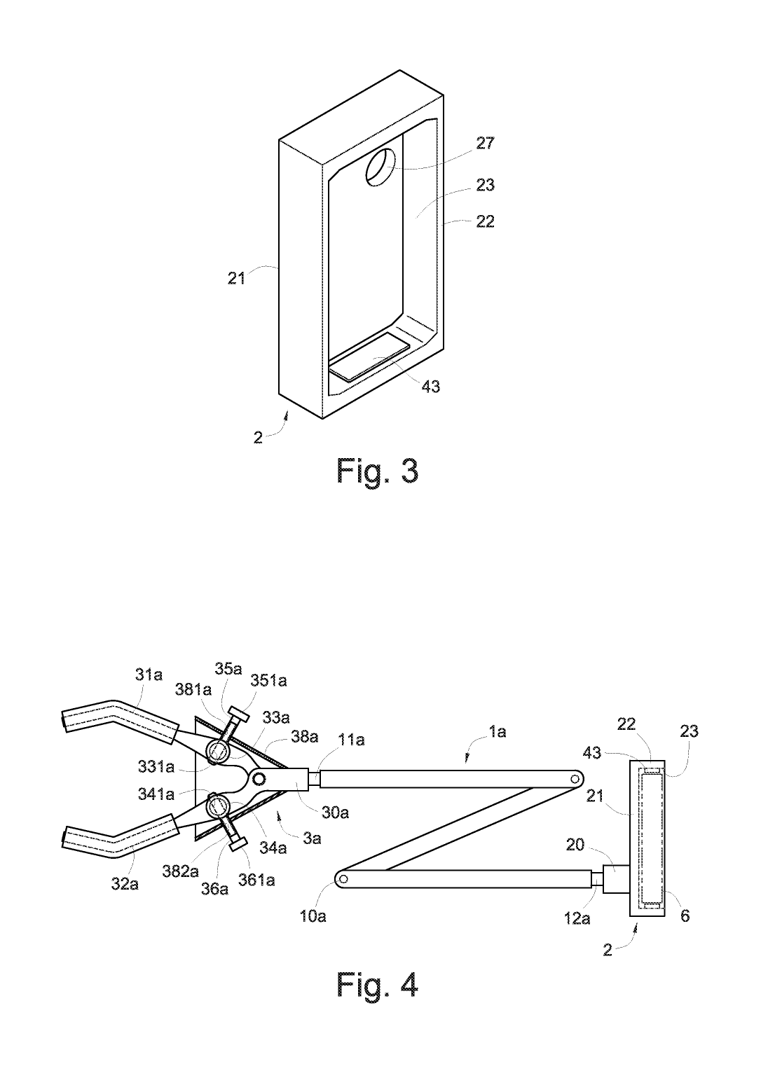

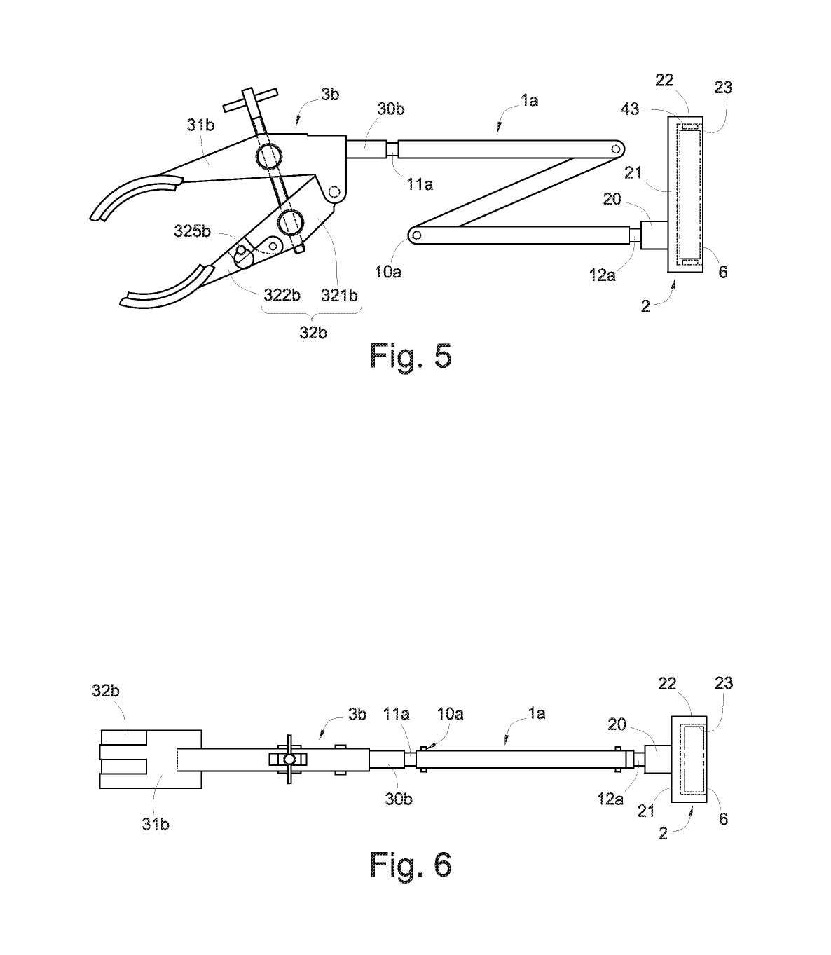

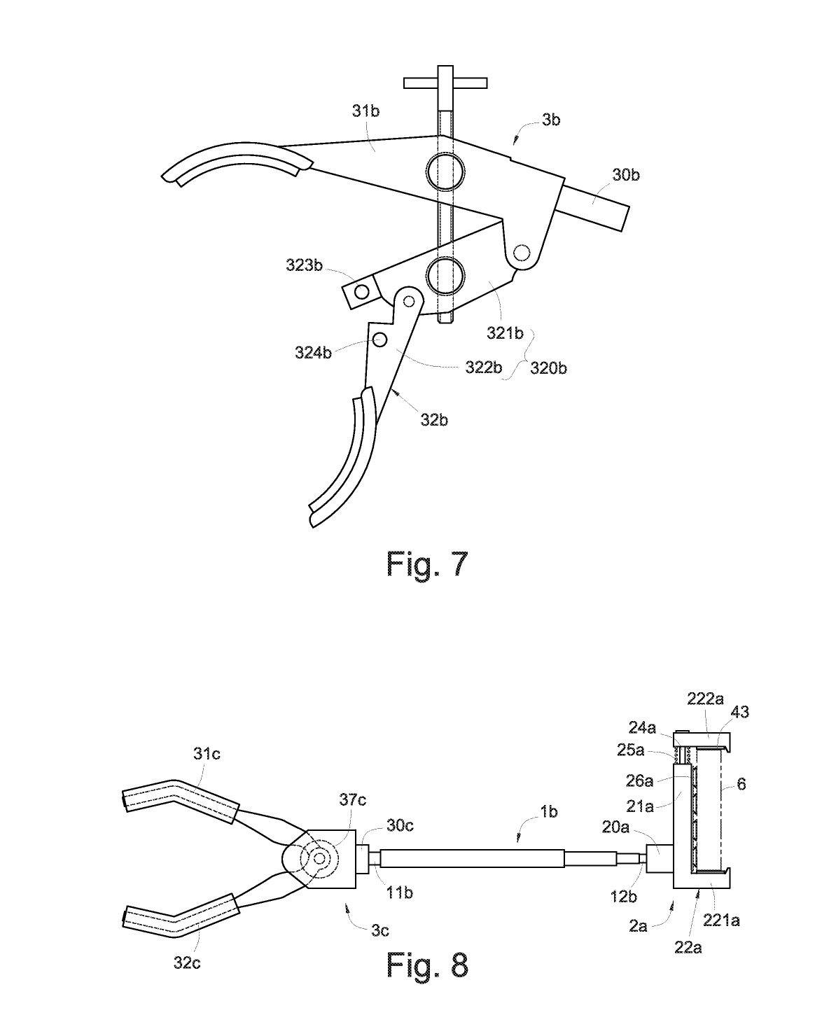

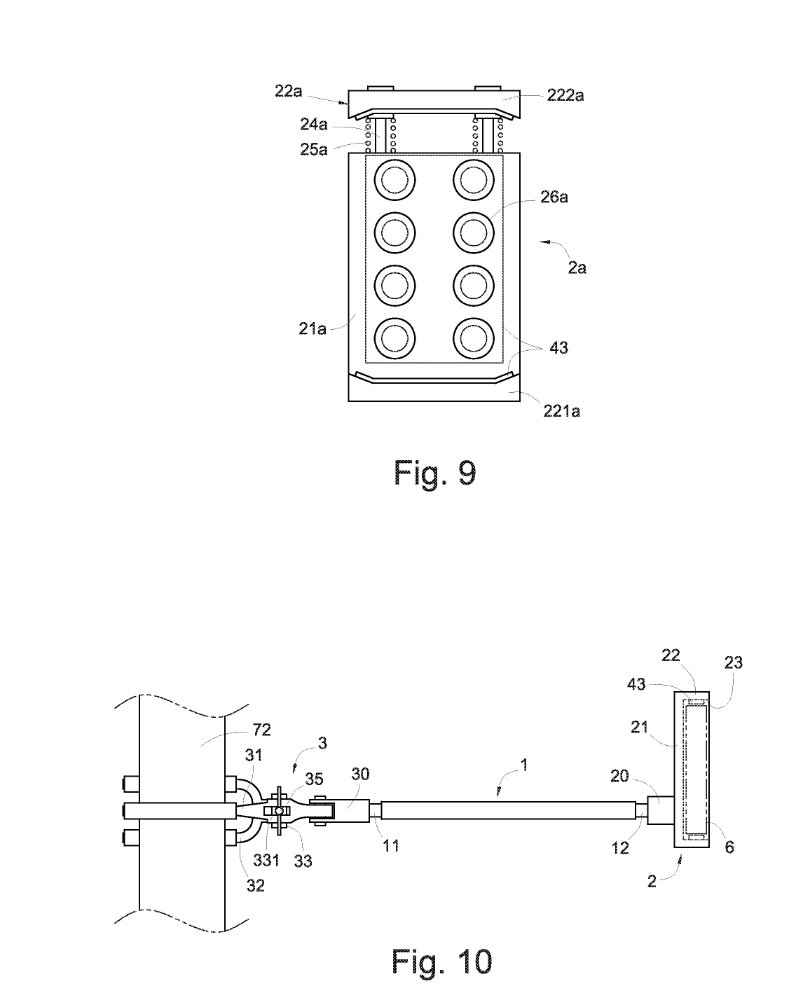

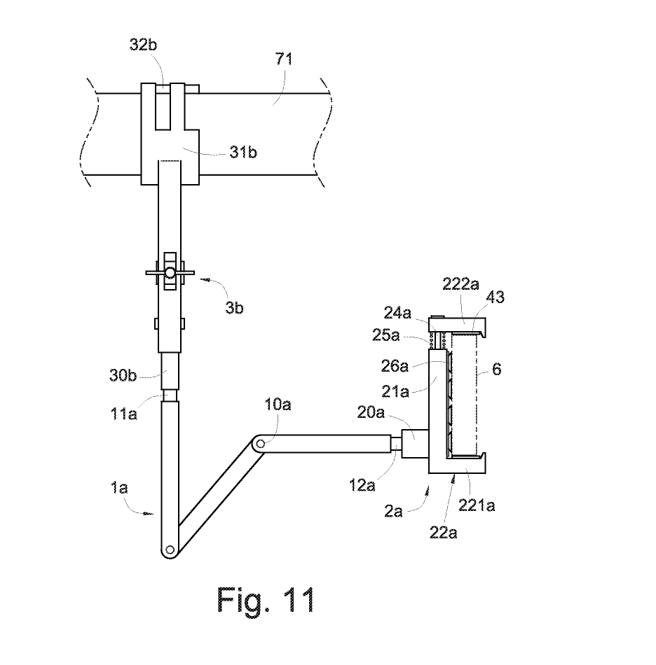

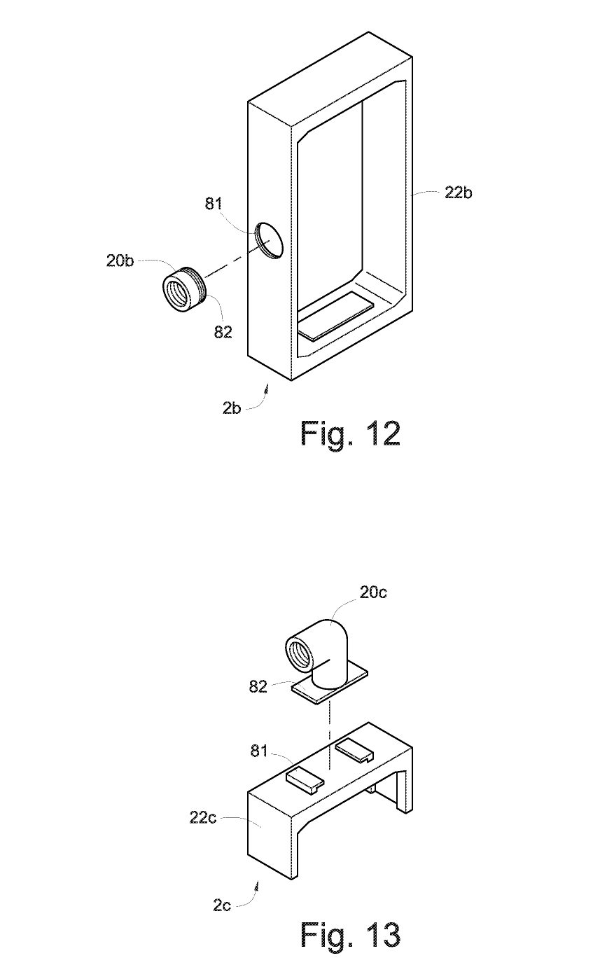

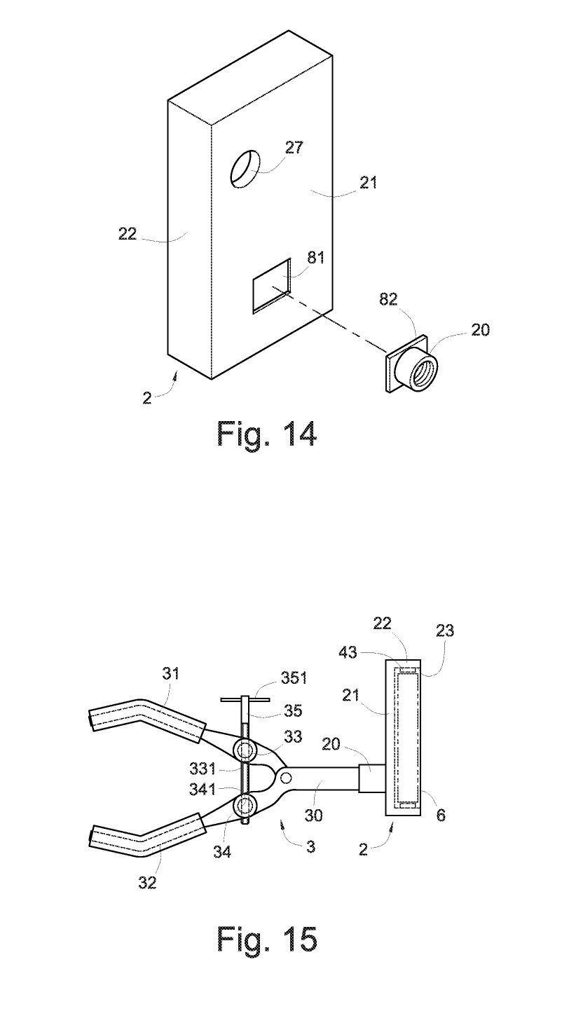

What is claimed is:

1. A protective sheath working with a fixer for handheld, portable, mobile devices, the protective sheath comprising a positioning frame to engage with the external fixer, and the protective sheath being characterized in:
the positioning frame having an enclosure, the enclosure using an inner wall thereof to hold an external mobile device in position, and the positioning frame having a first connecting portion that is detachable and configured to engage with the fixer, which serves to fix the positioning frame onto an external article, thereby suspending the mobile device.

2. The protective sheath of claim 1, wherein the positioning frame has a base around which the enclosure is provided, so that the base and the inner wall of the enclosure jointly define a positioning recess for fittingly receiving the external mobile device, and the first connecting portion is deposited on the enclosure or on the base at a location corresponding to yet reverse to the positioning recess.

3. The protective sheath of claim 1, wherein the fixer comprises an extension rod and a securing member, and the first connecting portion of the positioning frame is deposited at one end of the extension rod, while the securing member is deposited at an opposite end of the extension rod for fixing the extension rod as well as the positioning frame onto the external article that is a planar or bar-like article, the extension rod being rigid in either a vertical direction or a horizontal direction, the securing member being configured to grasp a horizontal or vertical, planar or bar-like article, so that when a user touches and operates the mobile device, the mobile device is strongly positioned over the external article by the extension rod and the securing member, and is prevented from swinging and being displaced.

4. The protective sheath of claim 1, wherein the fixer comprises a securing member, and the first connecting portion of the positioning frame is deposited on the securing member, the securing member serving to fixing the positioning frame to the external article that is a planar or bar-like article, the securing member being configured to grasp a horizontal or vertical, planar or bar-like article, so that when a user touches and operates the mobile device, the mobile device is strongly positioned over the external article by the extension rod and the securing member, and is prevented from swinging and being displaced.

5. The protective sheath of claim 1, wherein the positioning frame has a surface, where the mobile device contacts, provided with a cushion, so as to enhance an anti-slip effect of the positioning frame on a surface of the mobile device.

6. The protective sheath of claim 2, wherein the enclosure comprises an immovable bracket fixedly deposited at one side of the base and a movable bracket movably provided at an opposite side of the base by slide, pull or rotation of a guide system, a rail system, a tooth-notch engagement system or a gear system, and the movable bracket and the immovable bracket being adjusted to fittingly receive the mobile device and then the movable bracket being driven by an embracing means, a screw means, an adhesive means, a hydraulic means, a surface-tension means, a pressuring means, a pulling spring, a suction means or a torque means to move toward the immovable bracket, so as to hold the mobile device firmly between the movable bracket and the immovable bracket regardless of how the mobile device is sized.

7. The protective sheath of claim 6, wherein the positioning frame has a surface, where the mobile device contacts, provided with a cushion, so as to enhance an anti-slip effect of the positioning frame on a surface of the mobile device.

8. The protective sheath of claim 7, wherein on the base of the positioning frame or on the cushion, there is provided at least one sucking disc for holding the mobile device, thereby ensuring close connection between the positioning frame and the mobile device to make the mobile device get secured firmly.

9. The protective sheath of claim 8, wherein the sucking disc is provided on the base or the cushion by forming integratedly, adhering, embedding or inserting

10. The protective sheath of claim 1, wherein the enclosure is a loop or a part of a reversed U shape.

11. The protective sheath of claim 1, wherein the positioning frame and the first connecting portion are combined through a first buckle member and a second buckle member that are configured to engage with each other, so that the first connecting portion is allowed to be rapidly assembled to and disassembled from the positioning frame, thereby when the first connecting portion is removed from the positioning frame, the positioning frame is able to be used as a normal, simple protective sheath for the mobile device.
